(19) United States
(12) Patent Application Publication
(10) Pub. No.: US 2015/0226153 A1
(43) Pub. Date: Aug. 13, 2015

(54) CYLINDER HEAD GASKET FOR HIGH LOAD AND MOTION APPLICATIONS

(71) Applicant: Federal Mogul Corporation, Southfield, MI (US)

(72) Inventors: Tyler Haberer, Southfield, MI (US); Takashi Okano, Commerce Township, MI (US); Daniel J. Vialard, Canton, MI (US)

(73) Assignee: Federal Mogul Corporation, Southfield, MI (US)

(21) Appl. No.: 14/179,961

(22) Filed: Feb. 13, 2014

(51) Int. Cl. F02F 11/00

(52) U.S. Cl. CPC F02F 11/002

(57) ABSTRACT

A cylinder head gasket including at least three functional layers and at least two stoppers is provided. The first functional layer includes a first full bead extending around a combustion chamber opening and axially aligned with a second full bead of the second functional layer. The first stopper extends along the first functional layer between the combustion chamber opening and the first full bead for preventing over-compression of the first full bead. The second stopper is located beneath the second full bead of the second functional layer for increasing load on the second full bead, reducing head lift, and promoting an even distribution of the load. The second stopper is not attached to the second functional layer along and adjacent the second full bead, and thus an air gap is present between the second stopper and the second full bead when the gasket is not compressed.

### BACKGROUND OF THE INVENTION

1. Field of the Invention

This invention relates generally to gaskets for providing a seal between two parts, and more particularly to multi-layer gaskets, such as cylinder head gaskets.

2. Description of the Prior Art

Gaskets are typically used to establish a gas and fluid tight seal between two parts clamped together, such as a cylinder head and an engine block of an internal combustion engine. Such gaskets oftentimes include a functional layer having a sealing bead, also referred to as an embossment, to facilitate the tight seal. The functional layer with the sealing bead is typically provided along with one or more additional layers, and the multiple layers are compressed together between the two clamped parts, in order to establish the gas and fluid tight seal. However, if the gasket is over-compressed, damage can occur to the sealing bead. For example, if the bead becomes substantially flattened, it loses its ability to exert a high compression sealing pressure, and fatigue cracks can form in the area of the bead.

### SUMMARY OF THE INVENTION

One aspect of the invention provides a gasket, such as a cylinder head gasket for an internal combustion engine. The gasket includes a first functional layer including a first outer surface and an oppositely facing first inner surface. The first functional layer extends between a first edge surrounding a combustion chamber opening and a second edge. A portion of the first outer surface and the first inner surface extend in a first direction to present a first full bead around the combustion chamber opening. The gasket also includes a second functional layer including a second inner surface facing the first inner surface and an oppositely facing second outer surface. The second functional layer extends between a third edge surrounding the combustion chamber opening and a fourth edge. A portion of the second inner surface and the second outer surface of the second functional layer extend in a second direction opposite the first direction to present a second full bead axially aligned with the first full bead. A first stopper extends along the first inner surface of the first functional layer between the first edge and the first full bead. A second stopper extends along the second outer surface of the second functional layer. The second stopper is attached to the second outer surface around the second full bead and is spaced from the second outer surface at the second full bead.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a radial cross-sectional side view of a cylinder head gasket according to a first exemplary embodiment of the invention;

FIG. 2 is a radial cross-sectional side view of a cylinder head gasket according to a second exemplary embodiment of the invention; and

FIG. 3 is a top view of the exemplary cylinder head gasket of FIG. 1, wherein the cross-section shown in FIG. 1 is taken along line 1-1 of FIG. 3.

### DESCRIPTION OF THE ENABLING EMBODIMENT

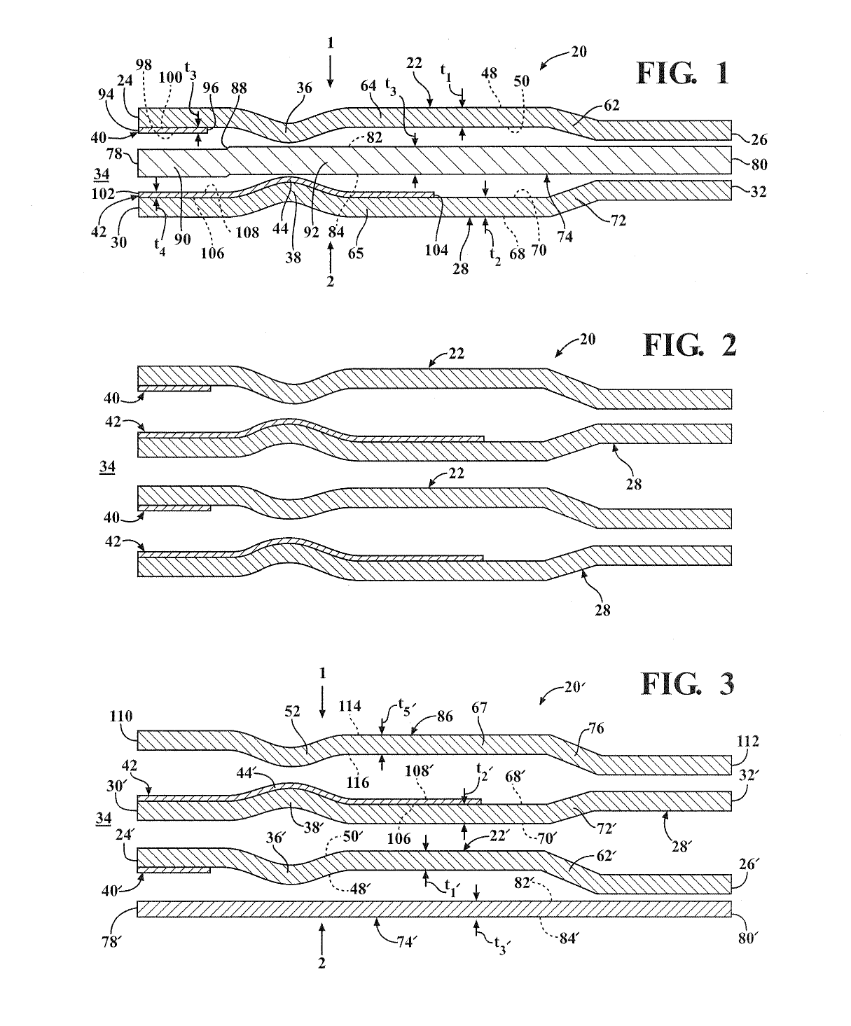

Referring to the Figures, wherein like numerals indicate corresponding parts throughout the several views, a multi-layer static gasket 20, 20′ providing improved performance under high loads and high motion is generally shown in FIGS. 1-3. The gasket 20, 20′ is typically used to establish a gas and/or fluid-tight seal between two components clamped together, for example between a cylinder head and engine block and around a combustion chamber opening 22, 22′. The gasket 20, 20′ includes a first functional layer 24, 24′ with a first full bead 26, 26′ and a second functional layer 28, 28′ with a second full bead 30, 30′ axially aligned with and facing toward the first full bead 26, 26′. A first stopper 32, 32′ is attached to the first functional layer 24, 24′ adjacent the combustion chamber opening 22, 22′ for preventing over-compression of the first full bead 26, 26′. A second stopper 34, 34′ is attached to the second functional layer 28, 28′ around the second full bead 30, 30′ for increasing load on the second full bead 30, 30′, promoting an even distribution of the load, and reducing head lift. The second stopper 34, 34′ is not attached to the second functional layer 28, 28′ adjacent the second full bead 30, 30′, and thus an air gap 36, 36′ is present between the second stopper 34, 34′ and the second full bead 30, 30′ when the gasket 20, 20′ is not compressed.

FIG. 1 is a cross-sectional view of the gasket 20 according to a first exemplary embodiment. The gasket 20 includes the first functional layer 24 extending continuously between a first edge 38 and a second edge 40. The first functional layer 24 also presents a first outer surface 42 and an oppositely facing first inner surface 44 each extending from the first edge 38 to the second edge 40. The first outer surface 42 and the first inner surface 44 present a thickness t₁ therebetween, which is typically constant from the first edge 38 to the second edge 40.

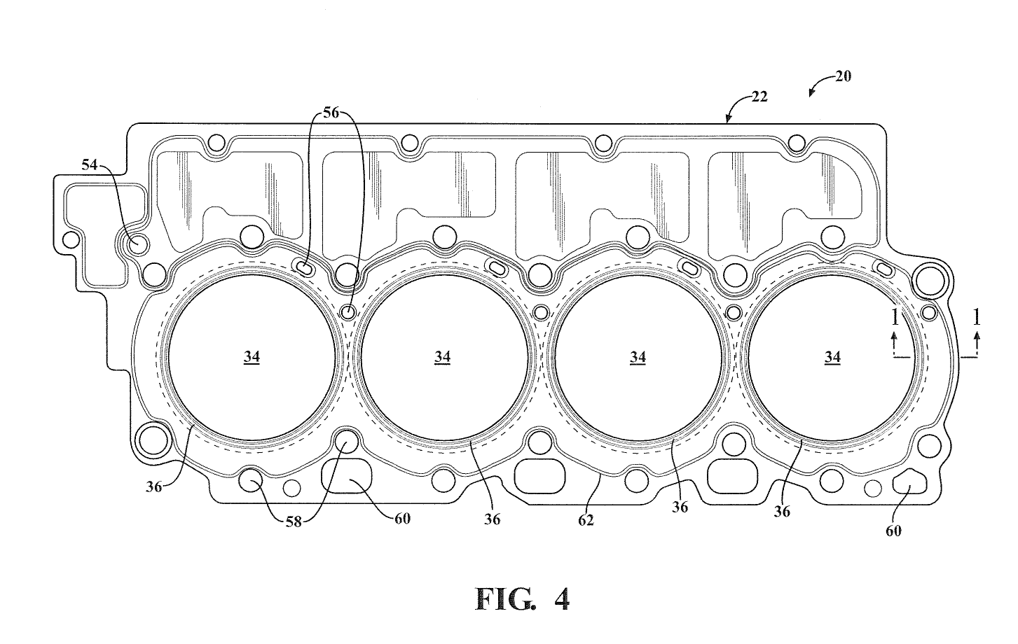

The first edge 38 of the first functional presents the combustion chamber opening 22. The combustion chamber opening 22 typically has a cylindrical shape, but could comprise other shapes. In the first exemplary embodiment, the first full bead 26 of the first functional layer 24 extends circumferentially and continuously around the first edge 38 presenting the combustion chamber opening 22. Typically, the gasket 20 includes multiple combustion chamber openings 22, each surrounded by one of the first full beads 26. FIG. 3 is a top view of the gasket 20 of FIG. 1 showing four combustion chamber openings 22 each having a cylindrical shape. However, the gasket 20 could include any number of combustion chamber openings 22, depending on the engine for which the gasket 20 is designed, and those openings could comprise another shape.

The second edge 40 of the first functional layer 24 typically presents an outer periphery of the gasket 20, or a secondary opening for allowing fluid or bolts to pass through. The exemplary gasket 20 of FIG. 3 includes several secondary openings, in addition to the combustion chamber opening 22, specifically oil feed holes 46, coolant metering holes 48, bolt holes 50, and oil drain back holes 52.

In the first exemplary embodiment, the first full bead 26 of the first functional layer 24 is disposed between the first edge 38 and the second edge 40, but closer to the first edge 38 than the second edge 40, as shown in FIG. 1. The first inner surface 44 and the first outer surface 42 of the first functional layer 24 extend inwardly in a first direction 1 to present the first full bead 26. The first inner surface 44 is convex along the first full bead 26, and the first outer surface 42 is concave along the first full bead 26. The first inner surface 44 and the first outer surface 42 of the first functional layer 24 include a first planar region 54 between the first edge 38 and the first full bead 26.

The first functional layer 24 of the first exemplary embodiment also includes a first half bead 56 disposed between the first full bead 26 and the second edge 40, as shown in FIG. 1. The first half bead 56 typically extends along the second edge 40, as shown in FIG. 3. The first inner surface 44 and the first outer surface 42 of the first functional layer 24 include a second planar region 58 between the first full bead 26 and the first half bead 56, and a third planar region 60 between the first half bead 56 and the second edge 40. A portion of the first inner surface 44 and the first outer surface 42 of the first functional layer 24 is disposed at an angle relative to the planar regions 54, 58, 60 and extends in the first direction 1 to present the first half bead 56.

The second functional layer 28 of the gasket 20 extends continuously between a third edge 64 aligned with the first edge 38 of the functional layer and a fourth edge 66 aligned with the second edge 40 of the first functional layer 24. The second functional layer 28 also presents a second outer surface 68 and an oppositely facing second inner surface 70 each extending from the third edge 64 to the fourth edge 66. The second outer surface 68 and the second inner surface 70 present a thickness t₂ therebetween. The thickness t₂ is typically constant from the third edge 64 to the fourth edge 66, and is typically equal to the thickness t₁ of the first functional layer 24.

The second functional layer 28 presents the second full bead 30 disposed between the third edge 64 and the fourth edge 66, but closer to the third edge 64 than the fourth edge 66, as shown in FIG. 1. A portion of the second inner surface 70 and the second outer surface 68 of the second functional layer 28 extend inwardly in a second direction 2, which is opposite the first direction 1 and toward the first functional layer 24, to present the second full bead 30. The second full bead 30 is axially aligned with the first full bead 26 of the first functional layer 24. In the first exemplary embodiment, the first full bead 26 and the second full bead 30 have contours which are mirror images of one another, as shown in FIG. 1. The second inner surface 70 of the second functional layer 28 is convex along the second full bead 30 and the second outer surface 68 of the second functional layer 28 is concave along the second full bead 30. The second inner surface 70 and the second outer surface 68 of the second functional layer 28 include a first planar region 55 between the third edge 64 and the second full bead 30. The second full bead 30 of the second functional layer 28 also extends circumferentially and continuously around the third edge 64 presenting the combustion chamber opening 22, just like the first full bead 26.

In the first exemplary embodiment, the second functional layer 28 includes a second half bead 72 disposed between the second full bead 30 and the fourth edge 66. The second half bead 72 is axially aligned with the first half bead 56, and the first half bead 56 and the second half bead 72 have contours which are mirror images of one another. The second half bead 72 typically extends along the fourth edge 66. The second inner surface 70 and the second outer surface 68 of the second functional layer 28 include a second planar region 59 between the second full bead 30 and the second half bead 72, and a third planar region 61 between the second half bead 72 and the fourth edge 66. A portion of the second inner surface 70 and the second outer surface 68 of the second functional layer 28 are disposed at an angle relative to the planar regions 55, 59, 61 and extend in the second direction 2 to present the second half bead 72, just like the second full bead 30.

The first stopper 32 of the gasket 20 extends along the first inner surface 44 of the first functional layer 24. The first stopper 32 also extends circumferentially around the first edge 38, between the first edge 38 and the first full bead 26, for preventing over-compression of the first full bead 26. The first stopper 32 includes a first stopper end 74 located at the first edge 38 and extends to a second stopper end 76 located between the first edge 38 and the first full bead 26. The first stopper 32 also presents a first stopper surface 78 extending along the first planar region 54 of the first functional layer 24 and a second stopper surface 80 facing opposite the first stopper surface 78 and toward the second functional layer 28. The first stopper surface 78 and the second stopper surface 80 are typically planar from the first stopper end 74 to the second stopper end 76. The first stopper surface 78 and the second stopper surface 80 also present a thickness t₃ therebetween. In the first exemplary embodiment, the thickness t₃ of the first stopper 32 is less than the thicknesses t₂, t₃ of the functional layers 24, 28. The first stopper surface 78 is attached to the first inner surface 44 of the first functional layer 24, and it is also attached continuously from the first stopper end 74 to the second stopper end 76. In the first exemplary embodiment, the first stopper surface 78 is welded, mechanically fixed, or clinched to the first inner surface 44 of the first functional layer 24, after the first full bead 26 is formed in the first functional layer 24. However, the first stopper 32 could be attached to the first functional layer 24 by other methods.

The second stopper 34 of the gasket 20 extends along the second outer surface 68 between the third edge 64 and the fourth edge 66 of the second functional layer 28. As shown in FIG. 1, the second stopper 34 extends along and beneath the second full bead 30 for increasing load on the second full bead 30 and promoting even distribution of the load. The second stopper 34 includes a third stopper end 86 aligned with the third edge 64 and extends to a fourth stopper end 88 located between the third edge 64 and the fourth edge 66, but closer to the third edge 64 than the fourth edge 66. The second stopper 34 presents a third stopper surface 90 extending along the second outer surface 68 of the second functional layer 28 and a fourth stopper surface 92 facing opposite the first stopper surface 78. The third stopper surface 90 and the fourth stopper surface 92 are planar from the third stopper end 86 to the fourth stopper end 88. The third stopper surface 90 and the fourth stopper surface 92 also present a thickness t₄ therebetween. In the first exemplary embodiment, the thickness t₄ of the second stopper 34 is not less than the thickness t₃ of the first stopper 32 and less than the thicknesses t₁, t₂ of the functional layers 24, 28. However, the thickness t₄ of the second stopper 34 could vary, for example it could be greater than, equal to, or less than the thickness t₃ of the first stopper 32.

As shown in FIG. 1, the third stopper surface 90 of the second stopper 34 is attached to the second outer surface 68 of the second functional layer 28 along the first planar region 55 and along the second planar region 59 of the second functional layer 28. However, third stopper surface 90 is spaced from the second outer surface 68 of the second functional layer 28 along the second full bead 30. When the gasket 20 is not compressed, i.e. when no pressure is applied to the functional layers 24, 28 of the gasket 20, the third stopper surface 90 is spaced from the second outer surface 68 by the air gap 36. The third stopper surface 90 is typically welded, mechanically fixed, or clinched to the second outer surface 68 along the first planar region 55 and along the second planar region 59 of the second functional layer 28. However, the third stopper surface 90 is not attached to the second outer surface 68 along and adjacent the second full bead 30 of the second functional layer 28, as shown in FIG. 1.

Although not required, the gasket 20 of the first exemplary embodiment also includes a third functional layer 82 disposed adjacent the fourth stopper surface 92 and the second outer surface 68 of the second functional layer 28. As shown in FIG. 1, third functional layer 82 and the first functional layer 24 have matching contours. The third functional layer 82 extends continuously between a fifth edge 94 aligned with the first edge 38 and a sixth edge 96 aligned with the second edge 40. The third functional layer 82 presents an third inner surface 98 facing the fourth stopper surface 92 of the second stopper 34 and the second outer surface 68 of the second functional layer 28 and an oppositely facing third outer surface 100 each extending from the fifth edge 94 to the sixth edge 96. The third outer surface 100 and the third inner surface 98 present a thickness t₅ therebetween, which is constant from the fifth edge 94 to the sixth edge 96. The thickness t₅ of the third functional layer 82 is typically equal to the thickness t₁ of the first functional layer 24 and the thickness t₂ of the second functional layer 28.

The third functional layer 82 also presents a third full bead 102 axially aligned with the first full bead 26 and the second full bead 30. The third full bead 102 and the first full bead 26 have matching contours, as shown in FIG. 1. The third full bead 102 is disposed between the fifth edge 94 and the sixth edge 96, but closer to the fifth edge 94 than the sixth edge 96. A portion of the third inner surface 98 and the third outer surface 100 of the third functional layer 82 extend in the first direction 1 to present the third full bead 102. The third inner surface 98 of the third functional layer 82 is concave along the third full bead 102 and the third outer surface 100 of the third functional layer 82 is convex along the third full bead 102. The third full bead 102 also extends circumferentially and continuously around the combustion chamber opening 22, just like the first full bead 26 and the second full bead 30. The third inner surface 98 and the third outer surface 100 of the third functional layer 82 include a first planar region 57 between the fifth edge 94 and the third full bead 102.

The gasket 20 of the first exemplary embodiment also includes a third half bead 104 disposed between the third full bead 102 and the sixth edge 96, and extending along the sixth edge 96. The third half bead 104 is axially aligned with the first half bead 56 and the second half bead 72, and the third half bead 104 and the first half bead 56 have matching contours. The third inner surface 98 and the third outer surface 100 of the third functional layer 82 include a second planar region 63 between the third full bead 102 and the third half bead 104, and a third planar region 65 between the third half bead 104 and the sixth edge 96. A portion of the third inner surface 98 and the third outer surface 100 of the third functional layer 82 are disposed at an angle relative to the planar regions 57, 63, 65 and extend in the first direction 1 to present the third half bead 104.

Each of the functional layers 24, 28, 82 and the stoppers 32, 34 are typically formed of a steel material. Preferably, the steel material includes chromium and nickel. Exemplary steel materials include SS301 fully hardened spring stainless steel material, cold rolled stainless steel, or SS304 annealed stainless steel.

A cross-section of a second exemplary embodiment of the gasket 20′ is shown FIG. 2. This gasket 20′ also includes the first functional layer 24′, second functional layer 28′, and third functional layer 82′ each including the full bead 26′, 30′, 102′. However, in FIG. 2, the first functional layer 24′ and the second functional layer 28′ are flipped upside down, so that the first full bead 26′ and the third full bead 102′ extend in the second direction 2 and the second full bead 30′ extends in the first direction 1. Also, according to the second exemplary embodiment, the first functional layer 24′ does not include the first half bead 56′, like the gasket 20 of the first exemplary embodiment. The gasket 20′ of the second exemplary embodiment also includes the first stopper 32′ attached to the first functional layer 24′ adjacent the combustion chamber opening 22′ for preventing over-compression of the first full bead 26′, and the second stopper 34′ attached to the second functional layer 28′ around the second full bead 30′ for increasing load on the second full bead 30′, promoting an even distribution of the load, and reducing head lift. As shown in FIG. 2, the second stopper 34′ is not attached to the second functional layer 28′ adjacent the second full bead 30′, and thus an air gap 36′ is present between the second stopper 34′ and the second full bead 30′ when the gasket 20′ is not compressed, like the first exemplary embodiment.

Unlike the gasket 20 of the first exemplary embodiment, the gasket 20′ of the second exemplary embodiment includes a third stopper 106 extending along the third outer surface 100′ of the third functional layer 82′ and circumferentially around the fifth edge 94′ and between the fifth edge 94′ and the third full bead 102′ for preventing over-compression of the third full bead 102′. The third stopper 106 extends from a fifth stopper end 108 located at the fifth edge 94′ to a sixth stopper end 110 located between the fifth edge 94′ and the third full bead 102′. The third stopper 106 also presents a fifth stopper surface 112 extending along the first planar region 57′ of the third outer surface 100′ of the third functional layer 82′ and a sixth stopper surface 114 facing opposite the fifth stopper surface 112. The fifth stopper surface 112 is attached to the third outer surface 100′ of the third functional layer 82′ continuously from the fifth stopper end 108 to the sixth stopper end 110. The fifth stopper surface 112 and the sixth stopper surface 114 are planar from the fifth stopper end 108 to the sixth stopper end 110, and the fifth stopper surface 112 and the sixth stopper surface 114 present a thickness t₆ therebetween. Typically, the third stopper 106 is of the same size and shape as the first stopper 32′. For example, the thickness t₆ of the third stopper 106 is typically equal to the thickness t₃′ of the first stopper 32′ and less than the thickness t₄′ of the second stopper 34. However, the thickness t₆ of the third stopper could vary. For example, the thickness t₆ of the third stopper 106 could be equal to or greater than the thickness t₄′ of the second stopper 34. The fifth stopper surface 112 is welded, mechanically fixed, or clinched to the third outer surface 100′ of the third functional layer 82′, but could be attached using other methods.

The gasket 20′ of the second exemplary embodiment shown in FIG. 2 also includes a fourth functional layer 84 disposed adjacent the sixth stopper surface 114 and the third outer surface 100′ of the third functional layer 82′. The fourth functional layer 84 and the second functional layer 28′ have matching contours, and the fourth functional layer 84 extends continuously between a seventh edge 116 aligned with the first edge 38′ and an eighth edge 118 aligned with the second edge 40′ of the first functional layer 24′. The fourth functional layer 84 presents a fourth inner surface 120 facing the sixth stopper surface 114 and the third outer surface 100′ of the third functional layer 82′. The fourth functional layer 84 also includes an oppositely facing fourth outer surface 122 each extending from the seventh edge 116 to the eighth edge 118. The fourth outer surface 122 and the fourth inner surface 120 present a thickness t₇ therebetween, which is constant from the seventh edge 116 to the eighth edge 118. The thickness t₇ of the fourth functional layer 84 is typically equal to the thicknesses t₁′, t₂′, t₅′ of the other three functional layers 24′, 28′, 82′.

As shown in FIG. 2, the fourth functional layer 84 presents a fourth full bead 124 axially aligned with the first full bead 26′, the second full bead 30′, and the third full bead 102′. The fourth full bead 124 and the second full bead 30′ have matching contours. The fourth full bead 124 is disposed between the seventh edge 116 and the eighth edge 118, but closer to the seventh edge 116 than the eighth edge 118. A portion of the fourth inner surface 120 and the fourth outer surface 122 of the fourth functional layer 84 extends in the first direction 1 toward the third functional layer 82′ to present the fourth full bead 124. The fourth inner surface 120 of the fourth functional layer 84 is convex along the fourth full bead 124 and the fourth outer surface 122 of the fourth functional layer 84 is concave along the fourth full bead 124. The fourth full bead 124 extends circumferentially and continuously around the combustion chamber opening 22′, just like the other full beads 26′, 30′, 102′. The fourth inner surface 120 and the fourth outer surface 122 of the fourth functional layer 84 include a first planar region 67 between the seventh edge 116 and the fourth full bead 124.

The fourth functional layer 84 also includes a fourth half bead 126 disposed between the fourth full bead 124 and the eighth edge 118 and axially aligned with the second half bead 72′ and the third half bead 104′. The fourth half bead 126 and the second half bead 72′ have matching contours, and the fourth half bead 126 extends along the eighth edge 118. The fourth inner surface 120 and the fourth outer surface 122 of the fourth functional layer 84 include a second planar region 69 between the fourth full bead 124 and the fourth half bead 126 and a third planar region 71 between the fourth half bead 126 and the eighth edge 118. A portion of the fourth inner surface 120 and the fourth outer surface 122 of the fourth functional layer 84 are disposed at an angle relative to the planar regions 67, 69, 71 and extend in the first direction 1 to present the fourth half bead 126. As in the first exemplary embodiment, each of the functional layers 24′, 28′, 82′, 84 and the stoppers 32′, 34′, 106 of the second exemplary embodiment are typically formed of a steel material, preferably a steel material including chromium and nickel.

Although not shown, the gasket 20, 20′ of either exemplary embodiment could include additional functional layers and stoppers stacked on top of the layers shown in FIGS. 1 and 2. In addition, the gasket 20, 20′ could include at least one distance layer disposed between or adjacent at least one of the functional layers for providing additional support, prevent over-compression, or adjust the distribution of the load along the gasket 20, 20′.

Obviously, many modifications and variations of the present invention are possible in light of the above teachings and may be practiced otherwise than as specifically described while within the scope of the appended claims.

What is claimed is:

1. A gasket, comprising:
a first functional layer including a first outer surface and an oppositely facing first inner surface and extending between a first edge surrounding a combustion chamber opening and a second edge;
a portion of said first outer surface and said first inner surface extending in a first direction to present a first full bead around said combustion chamber opening;
a second functional layer including a second inner surface facing said first inner surface and an oppositely facing second outer surface and extending between a third edge surrounding said combustion chamber opening and a fourth edge;
a portion of said second inner surface and said second outer surface of said second functional layer extending in a second direction opposite said first direction to present a second full bead axially aligned with said first full bead;
a first stopper extending along said first inner surface of said first functional layer between said first edge and said first full bead;
a second stopper extending along said second outer surface of said second functional layer; and
said second stopper being attached to said second outer surface around said second full bead and spaced from said second outer surface at said second full bead.

2. The gasket of claim 1 wherein said second stopper is spaced from said second outer surface at said second full bead by an air gap when said functional layers are not compressed.

3. The gasket of claim 1 wherein said first stopper extends along said first inner surface from a first stopper end axially aligned with said first edge to a second stopper end located between said first edge and said first full bead, and said first stopper extends circumferentially around said combustion chamber opening.

4. The gasket of claim 1 wherein said second stopper extends along said second outer surface from a third stopper end axially aligned with said third edge to a fourth stopper end located between said second full bead and said fourth edge, and said second stopper extends circumferentially around said combustion chamber opening.

5. The gasket of claim 1 wherein said first stopper presents a first stopper surface extending along said first inner surface of said first functional layer and a second stopper surface facing opposite said first stopper surface, and said first stopper surface and said second stopper surface are planar from a first stopper end to a second stopper end.

6. The gasket of claim 1 wherein said second stopper presents a third stopper surface extending along said second outer surface of said second functional layer and a fourth stopper surface facing opposite said third stopper surface; and said third stopper surface and said fourth stopper surface are planar from a third stopper end to a fourth stopper end.

7. The gasket of claim 1 wherein said stoppers and said functional layers each present a thickness, and said thickness of each stopper is less than said thickness of each functional layer.

8. The gasket of claim 1 wherein said first full bead and said second full bead extend inwardly toward one another.

9. The gasket of claim 1 wherein said stoppers are welded, mechanically fixed, or clinched to said functional layers.

10. The gasket of claim 1 including a third functional layer disposed adjacent said second outer surface of said second functional layer, said third functional layer including a third inner surface facing said second outer surface and an oppositely facing third outer surface and extending from a fifth edge to a sixth edge and including a third full bead axially aligned with said first full bead and said second full bead.

11. The gasket of claim 10 including a third stopper extending along said third outer surface of said third functional layer and circumferentially around said fifth edge and between said fifth edge and said third full bead for preventing over-compression of said third full bead.

12. The gasket of claim 11 wherein said third stopper presents a fifth stopper surface extending along said third outer surface of said third functional layer and a sixth stopper surface facing opposite said fifth stopper surface, and said fifth stopper surface and said sixth stopper surface are planar from a fifth stopper end to a sixth stopper end.

13. The gasket of claim 11 including a including a fourth functional layer disposed adjacent said third outer surface of said third functional layer, said fourth functional layer including a fourth full bead axially aligned with said other full beads.

14. The gasket of claim 13 wherein said third full bead extends in said first direction and said fourth full bead extends in said second direction.

15. The gasket of claim 1 wherein at least one of said first functional layer and said second functional layer includes a half bead extending in the same direction as said full bead of said functional layer.

16. The gasket of claim 1 wherein said first functional layer includes a first half bead disposed adjacent said second edge and extending in said first direction, and said second functional layer includes a second half bead axially aligned with said first half bead and extending in said second direction toward said first half bead.

17. The gasket of claim 1 wherein said first inner surface of said first functional layer is convex along said first full bead and said first outer surface of said first functional layer is concave along said first full bead.

18. The gasket of claim 17 wherein said second inner surface of said second functional layer is convex along said second full bead and said second outer surface of said second functional layer is concave along said first full bead.

19. A cylinder head gasket, comprising:
a first functional layer extending continuously between a first edge presenting a combustion chamber opening and a second edge, said combustion chamber opening having a cylindrical shape;
said first functional layer presenting a first outer surface and an oppositely facing first inner surface each extending from said first edge to said second edge;
said first outer surface and said first inner surface presenting a thickness therebetween, said thickness being constant from said first edge to said second edge;
said first functional layer presenting a first full bead disposed between said first edge and said second edge and closer to said first edge than said second edge;
said first inner surface and said first outer surface of said first functional layer extending inwardly in a first direction to present said first full bead;
said first inner surface of said first functional layer being convex along said first full bead and said first outer surface of said first functional layer being concave along said first full bead;
said first full bead extending circumferentially and continuously around said first edge presenting said combustion chamber opening;
said first inner surface and said first outer surface of said first functional layer including a first planar region between said first edge and said first full bead;
said first functional layer including a first half bead disposed between said first full bead and said second edge;
said first half bead extending along said second edge;
said first inner surface and said first outer surface of said first functional layer including a second planar region between said first full bead and said first half bead;
said first inner surface and said first outer surface of said first functional layer including a third planar region between said first half bead and said second edge;
a portion of said first inner surface and said first outer surface of said first functional layer being disposed at an angle relative to said planar regions and extending in said first direction to present said first half bead;
a second functional layer extending continuously between a third edge aligned with said first edge and presenting said combustion chamber opening and a fourth edge aligned with said second edge;
said second functional layer presenting a second outer surface and an oppositely facing second inner surface each extending from said third edge to said fourth edge;
said second outer surface and said second inner surface presenting a thickness therebetween, said thickness being constant from said third edge to said fourth edge;
said thickness of said second functional layer being equal to said thickness of said first functional layer;
said second functional layer presenting a second full bead disposed between said third edge and said fourth edge and closer to said third edge than said fourth edge;
said second inner surface and said second outer surface of said second functional layer extending inwardly in a second direction opposite said first direction and toward said first functional layer to present said second full bead;
said second full bead of said second functional layer being axially aligned with said first full bead of said first functional layer;
said first full bead and said second full bead having contours being mirror images of one another;
said second inner surface of said second functional layer being convex along said second full bead and said second outer surface of said second functional layer being concave along said second full bead;
said second full bead of said second functional layer extending circumferentially and continuously around said third edge presenting said combustion chamber opening;
said second inner surface and said second outer surface of said second functional layer including a first planar region between said third edge and said second full bead;
said second functional layer including a second half bead disposed between said second full bead and said fourth edge and axially aligned with said first half bead;
said first half bead and said second half bead having contours being mirror images of one another;
said second half bead extending along said fourth edge;
said second inner surface and said second outer surface of said second functional layer including a second planar region between said second full bead and said second half bead;
said second inner surface and said second outer surface of said second functional layer including a third planar region between said second half bead and said fourth edge;
a portion of said second inner surface and said second outer surface of said second functional layer being disposed at an angle relative to said planar regions and extending in said second direction to present said second half bead;
a first stopper extending along said first inner surface of said first functional layer circumferentially around said first edge and between said first edge and said first full bead for preventing over-compression of said first full bead;
said first stopper extending from a first stopper end located at said first edge to a second stopper end located between said first edge and said first full bead;
said first stopper presenting a first stopper surface extending along said first planar region of said first inner surface of said first functional layer and a second stopper surface facing opposite said first stopper surface and toward said second functional layer;
said first stopper surface and said second stopper surface being planar from said first stopper end to said second stopper end;
said first stopper surface being attached to said first inner surface of said first functional layer;
said first stopper surface being attached to said first inner surface continuously from said first stopper end to said second stopper end;
said first stopper surface being welded, mechanically fixed, or clinched to said first inner surface of said first functional layer;
said first stopper surface and said second stopper surface presenting a thickness therebetween;
said thickness of said first stopper being less than said thickness of said functional layers;
a second stopper extending along said second outer surface of said second functional layer and along said second full bead of said second functional layer between said third edge and said fourth edge for increasing load on said second full bead and promoting even distribution of the load;
said second stopper extending from a third stopper end aligned with said third edge to a fourth stopper end located between said third edge and said fourth edge and closer to said third edge than said fourth edge;
said second stopper presenting a third stopper surface extending along said second outer surface of said second functional layer and a fourth stopper surface facing opposite said first stopper surface;
said third stopper surface and said fourth stopper surface being planar from said third stopper end to said fourth stopper end;
said third stopper surface being attached to said second outer surface along said first planar region and along said second planar region of said second functional layer;
said third stopper surface being spaced from said second outer surface of said second functional layer along said second full bead by an air gap when said gasket is not compressed;
said third stopper surface being welded, mechanically fixed, or clinched to said second outer surface along said first planar region and along said second planar region of said second functional layer;
said third stopper surface being not attached to said second outer surface along said second full bead of said second functional layer;
said third stopper surface and said fourth stopper surface presenting a thickness therebetween;
said thickness of said second stopper being not less than said thickness of said first stopper and less than said thickness of said functional layers;
a third functional layer disposed adjacent said fourth stopper surface and said second outer surface of said second functional layer;
said third functional layer and said first functional layer having matching contours;
said third functional layer extending continuously between a fifth edge aligned with said first edge and a sixth edge aligned with said second edge;
said third functional layer presenting an third inner surface facing said fourth stopper surface of said second stopper and said second outer surface of said second functional layer and including an oppositely facing third outer surface each extending from said fifth edge to said sixth edge;
said third outer surface and said third inner surface presenting a thickness therebetween, said thickness being constant from said fifth edge to said sixth edge;
said thickness of said third functional layer being equal to said thickness of said first functional layer and said thickness of said second functional layer;
said third functional layer presenting a third full bead axially aligned with said first full bead and said second full bead;
said third full bead and said first full bead having matching contours;
said third full bead disposed between said fifth edge and said sixth edge and closer to said fifth edge than said sixth edge;
a portion of said third inner surface and said third outer surface of said third functional layer extending in said first direction to present said third full bead;
said third inner surface of said third functional layer being concave along said third full bead and said third outer surface of said third functional layer being convex along said third full bead;
said third full bead extending circumferentially and continuously around said combustion chamber opening;
said third inner surface and said third outer surface of said third functional layer including a first planar region between said fifth edge and said third full bead;
said third functional layer including a third half bead disposed between said third full bead and said sixth edge and axially aligned with said first half bead and said second half bead;
said third half bead and said first half bead having matching contours;
said third half bead extending along said sixth edge;
said third inner surface and said third outer surface of said third functional layer including a second planar region between said third full bead and said third half bead and a third planar region between said third half bead and said sixth edge;
a portion of said third inner surface and said third outer surface of said third functional layer being disposed at an angle relative to said planar regions and extending in said first direction to present said third half bead; and
each of said layers and said stoppers being formed of a steel material, said steel material including chromium and nickel.

20. The cylinder head gasket of claim 19 further comprising:
a third stopper extending along said third outer surface of said third functional layer and circumferentially around said fifth edge and between said fifth edge and said third full bead for preventing over-compression of said third full bead;
said third stopper extending from a fifth stopper end located at said fifth edge to a sixth stopper end located between said fifth edge and said third full bead;
said third stopper presenting a fifth stopper surface extending along said first planar region of said third outer surface of said third functional layer and a sixth stopper surface facing opposite said fifth stopper surface;
said fifth stopper surface being attached to said third outer surface of said third functional layer;
said fifth stopper surface being attached to said third outer surface continuously from said fifth stopper end to said sixth stopper end;
said fifth stopper surface and said sixth stopper surface being planar from said fifth stopper end to said sixth stopper end;
said fifth stopper surface being welded, mechanically fixed, or clinched to said third outer surface of said third functional layer;
said fifth stopper surface and said sixth stopper surface presenting a thickness therebetween;
said thickness of said third stopper being equal to said thickness of said first stopper;
a fourth functional layer disposed adjacent said sixth stopper surface and said third outer surface of said third functional layer;
said fourth functional layer and said second functional layer having matching contours;
said fourth functional layer extending continuously between a seventh edge aligned with said first edge and a eighth edge aligned with said second edge of said first functional layer;
said fourth functional layer presenting an fourth inner surface facing said sixth stopper surface and said third outer surface of said third functional layer and including an oppositely facing fourth outer surface each extending from said seventh edge to said eighth edge;
said fourth outer surface and said fourth inner surface presenting a thickness therebetween, said thickness being constant from said seventh edge to said eighth edge;
said thickness of said fourth functional layer being equal to said thickness of said other functional layers;
said fourth functional layer presenting a fourth full bead axially aligned with said first full bead and said second full bead and said third full bead;
said fourth full bead and said second full bead having matching contours;
said fourth full bead disposed between said seventh edge and said eighth edge and closer to said seventh edge than said eighth edge;
a portion of said fourth inner surface and said fourth outer surface of said fourth functional layer extending in said second direction toward said third functional layer to present said fourth full bead;
said fourth inner surface of said fourth functional layer being convex along said fourth full bead and said fourth outer surface of said fourth functional layer being concave along said fourth full bead;
said fourth full bead extending circumferentially and continuously around said combustion chamber opening;
said fourth inner surface and said fourth outer surface of said fourth functional layer including a first planar region between said seventh edge and said fourth full bead;
said fourth functional layer including a fourth half bead disposed between said fourth full bead and said eighth edge and axially aligned with said first half bead and said second half bead and said third half bead;
said fourth half bead and said second half bead having matching contours;
said fourth half bead extending along said eighth edge;
said fourth inner surface and said fourth outer surface of said fourth functional layer including a second planar region between said fourth full bead and said fourth half bead and a third planar region between said fourth half bead and said eighth edge; and
a portion of said fourth inner surface and said fourth outer surface of said fourth functional layer being disposed at an angle (α) relative to said planar regions and extending in said second direction to present said fourth half bead.
